(19) United States
(12) Patent Application Publication
(10) Pub. No.: US 2018/0212845 A1
(43) Pub. Date: Jul. 26, 2018

(54) NETWORK RESOURCE HANDLING

(71) Applicant: TELEFONAKTIEBOLAGET LM ERICSSON (PUBL), Stockholm (SE)

(72) Inventors: Hans ERIKSSON, Sollentuna (SE); Göran ERIKSSON, Norrtälje (SE); Mathias SINTORN, Sollentuna (SE)

(21) Appl. No.: 15/747,748

(22) PCT Filed: Jul. 28, 2015
(86) PCT No.: PCT/EP2015/067313

§ 371 Date: Jan. 25, 2018

(51) Int. Cl. H04L 12/26; H04L 12/911; H04L 12/813; H04L 12/851; H04L 12/825; H04L 29/06

(52) U.S. Cl. CPC H04L 43/08; H04L 47/70; H04L 69/22; H04L 47/24; H04L 47/25; H04L 47/20

(57) ABSTRACT

A method of managing network resources across a broadband access network. A slice of the total available network resources is allocated to an application service provider, where the service provider utilises said slice to provide one or more services to a multiplicity of client devices. Traffic is monitored in a transport layer of the broadband access network to determine one or more parameters indicative of traffic flow. Said parameter(s) are passed to the application layer at an application layer end point of the application service. The parameter(s) are used at the application layer to manage traffic specific to the services and achieve efficient use of said slice.

### TECHNICAL FIELD

The present invention relates to network resource handling and in particular to handling resources provided by a broadband access network such as a mobile broadband network.

### BACKGROUND

Any IP based software application will typically include a set of endpoints connected by TCP/IP. More recent applications may include transport protocols such as SCTP (Stream Control Transmission Protocol) or QUIC (Quick UDP Internet Connections) in place of TCP. Additionally, applications typically use application layer protocols such as HTTP, which are carried within the transport protocols, to establish sessions between the application end points. The transport protocols (and some application player protocols such as HTTP/2) include rate control mechanisms for managing network load, known as congestion control, as well as resource management at the end points, known as flow control. Both of these control types affect the rate at which the sender sends data.

One characteristic of such modern protocols is that they take advantage of the increased speed of current hardware in order to implement the protocols in user-space processes and/or scripting environments (e.g. JavaScript).

The original TCP/IP stack was designed for a system in which the endpoints had limited processing capacity and the overall design aim was to provide a resilient system which required little intelligence in the network (particularly in the network layer). Transport resources such as links were heavily overprovisioned, as the processing power required to coordinate heavily in the network layer would have caused a significant bottleneck at the time. The protocols, particularly TCP, were designed to probe their way to maximum network usage by finding the point where congestion occurred, backing off, and then slowly ramping up later until a congestion limit was found.

TCP has minimal interaction between the transport and application layers. The applications are ignorant to the network topology, and rely on the TCP flow and congestion control to ensure that data is transferred at a reasonable speed. This was quite sufficient for the applications of the time (email, file transfer, chat, etc.) and the business context (academia).

However, the development of the internet, including the web and other services, has resulted in a situation where large software application delivering mass-market user experiences such as TV, real time communication, and gaming are using TCP/IP stacks (or related protocols) which were not designed with real-time communication ins mind, and are not optimal for providing good user experience in the modern world.

In order to mitigate these problems, current flow and congestion control systems analyse packets in order to identify areas of congestion, and drop packets as required to ensure a good average quality of service (QoS), e.g. preferring to drop non-real-time services over real-time services, or preferring premium users to regular users. In order to provide such differentiated treatment, the network must be aware of the services, user, and/or other details of the packet.

Deep packet inspection (DPI) is often used to identify the properties of a packet for QoS monitoring. However, DPI and other similar techniques do not work on encrypted or compressed packets—the data being transmitted is essentially random from the point of view of the intermediate nodes, and so little information about the packet can be obtained. Existing solutions to handling encrypted data rely on heuristics to identify packet flows, or depend on the application providing unencrypted metadata in parallel with the packet stream for use in QoS monitoring. However, heuristics require significant computational resources, and are often imprecise, and many applications do not provide metadata, or combine several application flows into a single transport stream, which does not enable the network to treat them individually.

Often, an application service provider will purchase a “slice” of a broadband access network. This “slice” guarantees traffic relating to the application a certain portion of the total available network resources (e.g. bandwidth). The slice may apply only to certain connections within the access network, or have different network resource limits for different connections within the network. The application may use network resources outside of the slice, but only the application traffic within the slice is treated preferentially.

As an example, consider the network schematically shown in FIG. 1. A content provider controls a content source 101, and two edge cache servers 102 and 103, which provide content to user equipment (UEs) 104a to 104c. The edge cache servers 102 and 103 connect to the content source 101 via a long distance network 105, and to the terminals via a mobile network 106, which contains several cells 107a to 107c. The edge caches are also connected to each other, which may be via the mobile network or the long distance network.

The content provider may have an agreement with the mobile network operator such that the content provider has a slice of 20% of the network resources between the edge cache and terminals served by the edge cache, in order to ensure good quality of service for the terminals.

The content provide may also have an agreement with the long distance network operator that the content provider has a slice with a certain guaranteed bandwidth of the long distance network, in order to ensure that the edge caches are kept up to date.

### SUMMARY

According to a first aspect of the present invention, there is provided a method of managing network resources across a broadband access network. A slice of the total available network resources is allocated to an application service provider, where the service provider utilises said slice to provide one or more services to a multiplicity of client devices. Traffic is monitored in a transport layer of the broadband access network to determine one or more parameters indicative of traffic flow. Said parameter(s) are passed to the application layer at an application layer end point of the application service. The parameter(s) are used at the application layer to manage traffic specific to the services and achieve efficient use of said slice.

According to a second aspect, there is provided apparatus configured to operate as an application layer end point for an application service in a broadband access network, wherein the application service utilises a slice of the broadband access network which is allocated to the application service. The apparatus comprises a transceiver and a processor. The transceiver is configured to communicate with the broadband access network. The processor is configured to:

receive from a transport layer entity, via the transceiver, one or more parameters indicative of traffic flow of the broadband network;

pass said parameters to an application layer process use the parameter(s) at the application layer to manage traffic specific to the services and achieve efficient use of said slice.

According to a third aspect, there is provided a method of managing network resources across a broadband access network. A proxy is provided for communications between first and second end nodes of the broadband access network, said communications comprising application layer packets encapsulated within encrypted transport layer packets, the application layer packets comprising encrypted payload, wherein the proxy is configured to act as an end point for the transport layer packets. Said transport layer packets are decrypted at the proxy. Said communications are monitored at the proxy, including examining headers of the application layer packets. Results of said monitoring are used to manage traffic within the broadband access network.

According to a fourth aspect, there is provided apparatus configured to operate as a proxy in a broadband access network. The apparatus comprises a transceiver, a proxy unit, a decryption unit, and a traffic monitoring unit. The transceiver is configured to communicate with the broadband access network. The proxy unit is configured to provide a proxy for communications between first and second end nodes of the broadband access network, said communications comprising application layer packets encapsulated within encrypted transport layer packets, the application layer packets comprising encrypted payload, wherein the proxy unit is configured to act as an end point for the transport layer packets. The decryption unit is configured to decrypt the transport layer packets. The traffic monitoring unit is configured to monitor said communications, including examining headers of the application layer packets, and to provide results of said monitoring to a control function of the broadband access network or use results of said monitoring to manage traffic within the broadband access network.

According to a further aspect, there is provided a computer program comprising computer readable code which, when run on an apparatus, causes the apparatus to perform a method according to the first or third aspect.

Further embodiments of the invention are set out in the appended claims.

### BRIEF DESCRIPTION OF THE DRAWINGS

FIG. 1 is a schematic diagram of an exemplary network;

FIG. 2 is a schematic diagram of data flows according to an embodiment;

FIG. 3 is a schematic diagram of a further exemplary network;

FIG. 4 is a flowchart of a method according to an embodiment;

FIG. 5 is a schematic diagram of an apparatus according to an embodiment;

FIG. 6 is a flowchart of a method according to a further embodiment;

FIG. 7 is a schematic diagram of an apparatus according to a further embodiment.

### DETAILED DESCRIPTION

It is in the interest of the application service provider (such as the content provider in the above example) to keep the traffic used by the application within the slice. Traffic outside of the slice is subject to throttling to reduce network congestion, and this may significantly affect QoE (Quality of Experience) for users of the application. However, the application service provider is not typically aware of congestion within the network at any level of detail. Current network level congestion monitoring techniques are implemented entirely within the network, and may at best give a notification of congestion to endpoints, without providing more detailed information. The network is not best placed to effectively throttle application traffic, as if the application traffic is encrypted or compressed, the network has no access to the payload and therefore cannot distinguish which traffic will have the greatest effect on QoE if it is dropped, and even if the network can see the payload of the traffic, it is not necessarily aware of which data is most important.

Therefore, a solution is proposed where the network layer passes certain information about the congestion on the network links and the usage of the application slice to the application layer at the end-points for application traffic, and the application then modifies the traffic being sent accordingly. This allows the flow control and congestion management responses to act outside of end-to-end encryption on the application flows, and opens up the possibility of responses such as increasing the size of a send buffer in the application, or fine control of application bitrates in order to provide the best possible QoE while limiting congestion.

The “application layer” and “network layers” referred to above are the layers of the Internet Protocol Suite. The transport layer contains the protocols and software responsible for host-to-host communications on either the local network or remote networks separated by routers. The application layer contains the higher level processes which make use of the transport layer (and lower layers) to provide communication to other hosts. Example transport layer protocols include TCP, UDP, and QUIC. Example application layer protocols include HTTP, SMTP, FTP, or any other application traffic which is encapsulated within a transport layer packet.

The information passed back to the application may include:
The network resources used by application services, which may be presented as a proportion of the total network resources or as a proportion of the network slice network resources.
The number of terminals using application services over the network.
The total level of congestion of the broadband network or the level of congestion in individual areas (e.g. cells) of the network.

This information may be given for the whole network, or for individual areas of the network (such as cells in a mobile broadband network), or for individual terminals which use the application services. The network may report this information regularly, or alert the application when any of the above parameters reaches a threshold value as requested by the application, or whenever the network considers it appropriate to report the information.

The network may also provide details of priority queues to the application, e.g. different bearers in a mobile network. The priority queues may be set up to allow the network to prioritise traffic sent by the application. The application can place traffic with a high QoS (Quality of Service) requirement in a high priority queue, ensuring that it is not throttled, while lower priority traffic may be placed in a lower priority queue.

The network may also provide a parameter which the application can use to report responses to congestion, or to request specific handling for certain flows or classes of flows. For example, the application may request that the radio scheduler terminates a specific flow, inform the radio scheduler of a new expected traffic rate based on the traffic management performed, or request that the radio scheduler set certain priorities for application flows.

As well as monitoring and reporting the network resources used, the network may also monitor and report resource utilisation in the core network to the application. The reported information may include the number of terminals registered for application services, subscription-related policies for those terminals (such as data caps or QoS requirements).

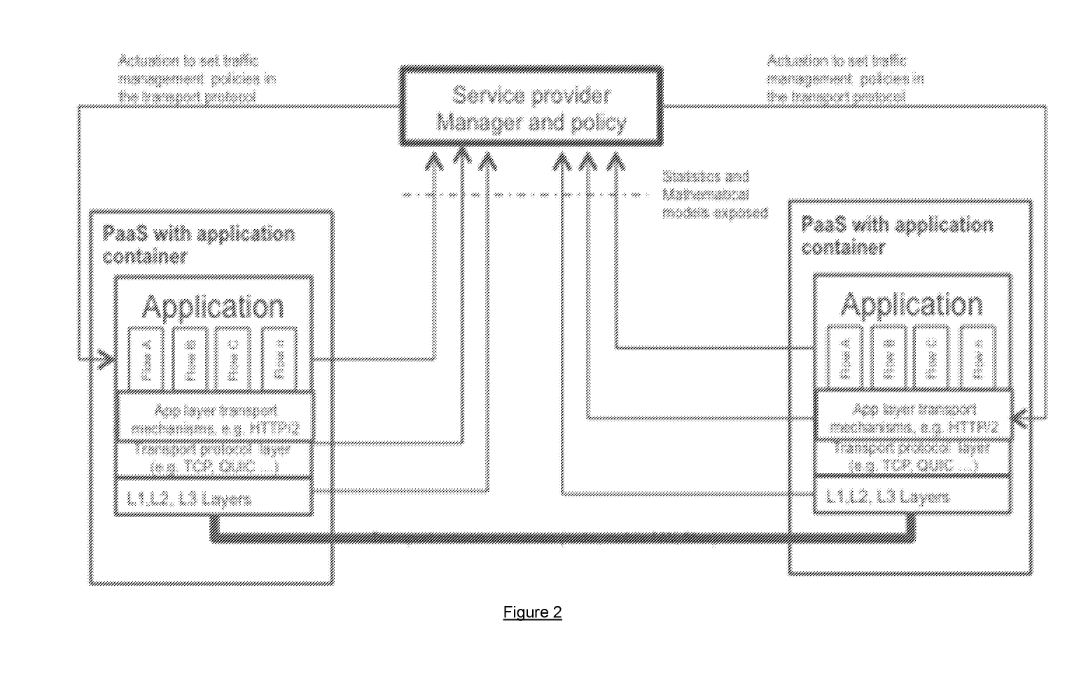

The transport protocol end-points are in the Terminal and in the Server as shown in the FIG. 2, where an application protocol such as HTTP/2 or a transport protocol stack which interacts with the application layer such as QUIC act. A transport capabilities enforcement point is able to be controlled remotely and provide data to central entity including the ability to operate on individual application requests and responses for data associated to an individual flow, sometimes known as stream.

The connectivity resources are exposed to the applications using the HTTP API or QUIC API, and changes in the available resources situation are perceived as congestion by the application. The congestion may for instance be detected due to an API send buffer emptying slowly or not at all, or by explicit congestion notifications.

The end points are managed and controlled by a central entity, which may be an application server, or may be another node that manages and controls both the application servers and the terminals. This entity leverages data to model the behaviour of both applications and transport characteristics, and, using the SLA, set a target behaviour for each end point.

The central entity supervises the behaviour of the transport layer, analyses changes and controls the end points, orchestrates the overall traffic behaviour and application experience of the transport layer.

An exemplary control scheme includes at least two control process layers; an inner layer for each application session and an outer layer for supervising and controlling the overall system. The outer layer models the system, and using various data sources including data from the inner processes, verifies the models. The model is used to decide on guidelines, policies or settings given to the inner processes.

This control scheme includes functions to:
1. Control load level on an individual endpoint and application flow perspective.
2. Control the load such that the capacity utilization is more or less close to 100%, including by causing certain application flows to believe the actual round trip time (RTT) and throughput is lower than it actually is.

The above two functions are relevant to provide for differentiated treatment, shaping and policing.

In a typical scenario, the underlying connectivity network—managed or not—offers a connectivity slice whose behaviour is not static but can vary. The variation is assumed to be possible to describe mathematically, as a function or using statistic models. In an example situation, the outer loop supervises the system behaviour and detects a situation, e.g. a pattern, that with certain possibility indicate an upcoming drop in capacity or characteristics. This event triggers an automated action to provide a changed experience in selected set of endpoints using the transport endpoint stack. This includes the outer loop sending an instruction to the applicable inner loops and end points in theses loops, the instruction specifying the behaviour the local transport stack should execute.

In an example embodiment, the overall control of the content delivery is typically done in an automated manner using a double control-loop approach:

An inner closed control loop among other things responsible for controlling the flow and congestion control functions in the end-points such as terminals as per instructions by the outer loop. For this purpose, it uses a protocol.

An outer control loop controlling and supervising a set of inner loops to a set of terminals (such as all of the UEs in a mobile network cell). It is responsible for deciding how radio congestion, as reported by the network layer, should be mapped onto application flow control and congestion. It also provides means for splitting the slice resources between terminals and between application flows for a single terminal. It sets the target performance goals of the inner loops. The inner loops are controlled by the outer loop, which provides policies to be implemented by the inner loop.

The inner loop controls the transport and application protocol mechanisms for congestion, and when applicable, flow control. It performs these actions based on policies given to it by the outer loop.

One example of a directive is a maximum bitrate of an application flow, which may be expressed as absolute value or a percentage of available network resources. In one embodiment, the enforcement of such a directive is done such that the senders transport stack receives instructions using in-built protocol means for exposing certain rate or congestion feedback to the sender. Similarly, in case of flow control, flow control messages may be used to emulate an appropriate buffer level, causing the sender to throttle up or down.

Thus, Radio slice information about a congestion event can be used by the application to share the RAN slice resources as desired between flows.

The RAN will only see a flow of encrypted packets. It provides its view on the weight of every flow to the application, meaning the portion of the cell and slice load as well as effect of throttling that particular flow. But the encrypted packets may carry application messages from different sub-streams, only visible to the application. Therefore, the application needs to keep track on which impact each sub-stream has. One example is when streaming video segments are multiplexed with control protocol messages, images and chat application message on the same encrypted channel.

Example actions for different Radio feedback events:
Lcong event: Radio level at configured congestion level.
   Outer loop correlates with application flow knowledge to learn patterns for predicting radio resource congestion.
   Outer loop decides to throttle all sessions down to a load level corresponding to a level guaranteed by a SLA (service level agreement), for instance only 20% of the cell.
   Inner loop may execute directive using flow control and congestion control in end-point for changing application behavior. Example is to throttle individual stream in bundle of stream on same transport channel to leave room for more important streams. The inner loop may make use of QUIC traffic management mechanisms.
Lcong event with App_Stream_Weight for all terminals in the slice: The outer loop may use this to throttle traffic from terminals in slice. The actual execution may be done by the Outer loop providing a policy to the inner loop to at autonomously. Another example if when the application throttles sub-streams of a certain kind; Outer loop instructs Inner loop to throttle all sub-streams of certain type.

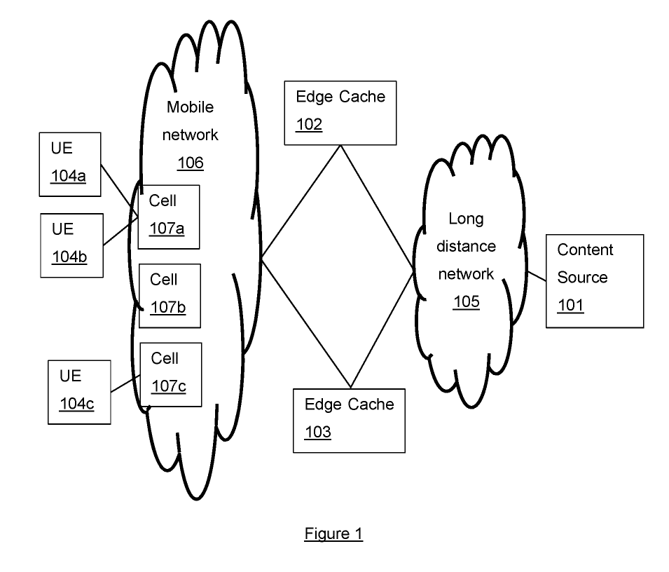

As an example, using the network shown in FIG. 1, the edge cache servers may implement the outer loop to control traffic on the mobile network, with a separate inner loop for each connection between the edge cache servers and the terminals. The access network reports that the network utilization by the application has increased above a threshold level. The edge cache server may then issue a policy on the outer loop, stating that all terminals with a certain subscription level should reduce the network usage to a lower value. The inner loop for each affected terminal will then determine how this usage reduction can be implemented, e.g. by reducing a bitrate of content streamed to the terminal, or by selectively reducing the bitrate of certain content. For example, real-time features of the application may be prioritized over other features.

An alternative method of handling encrypted traffic is to place a proxy within the network for such traffic, where the proxy acts as an end point to at least transport layer encryption, and potentially also application layer encryption. For example, the proxy may be configured such that, when handling packets with transport layer encryption, it can decrypt those packets and examine the packet headers of the encapsulated application layer packets, but not the content of the application layer packets (in order to maintain security). Alternatively, the proxy may be configured such that it can decrypt both the transport layer and application layer packets in order to view the payload of the application layer packets. The latter option may not be suitable for all applications due to privacy and security concerns, but it would allow the proxy to monitor more features of the application layer packets and therefore make more informed flow and congestion control decisions.

In a typical embodiment, the proxy is an HTTP proxy with connections to client and server end-points. The client and server end-points exchange messages carried by HTTP connections as encrypted payloads in HTTP packets. Additionally, the HTTP packets are transported in encrypted transport layer packets such as QUIC or TLS (Transport Layer Security) on TCP. The proxy is an endpoint for the HTTP and QUIC/TLS protocols.

Because the proxy acts as an application connection protocol and transport protocol end-point, it can apply congestion and flow control or priority mechanisms easily. The proxy may also alter headers of the application layer packets, for example to alter priorities of the packets, or perform other traffic policing and shaping. Alternatively, the congestion and flow control mechanisms may be applied by a control function of the broadband access network.

The proxy performs packet analysis in order to determine appropriate congestion and flow control responses, and may interface with other policy functions of the broadband access network (e.g. a Policy Charging Rules Function, PCRF, in a mobile network) to obtain traffic management policies for the network.

The traffic management may be performed for purposes such as managing QoS, managing power consumption, etc.

The proxy may be preconfigured with policies, or may receive policies from a policy function of the broadband access network. Such policies may include throttling application streams of a certain type or characteristics when certain congestion situations arise.

Where the proxy does not act as an end-point for application layer encryption, metadata about the contents of the application layer packets may be provided by the sending end node, so that the proxy can use the data to make congestion management decisions. Such metadata may be provided in an encrypted and/or integrity protected form.

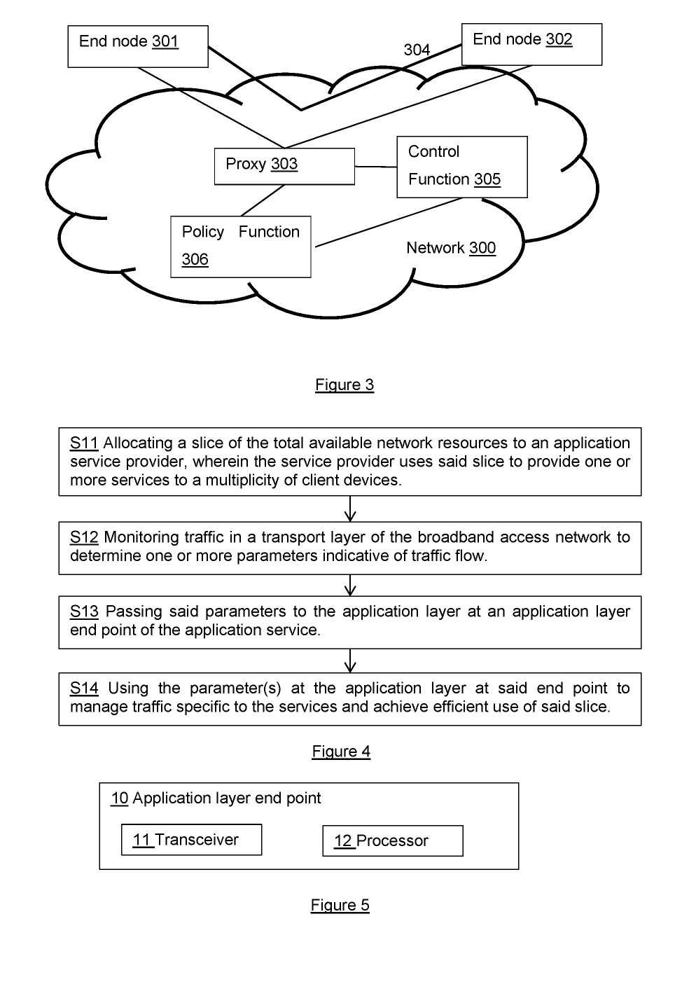

As an example, with reference to FIG. 3, the network protocol may be TCP/IP, and the application protocol may be HTTP. Traffic sent between two end-nodes 301 and 302 over the network 300 is encrypted both at the network layer and at the application layer. The proxy 303 acts as an end point for all network layer encryption, and for certain application layer encryption.

For example, the end-nodes may encrypt less secure data such that the proxy acts as an end point for application layer encryption and the data is exposed for traffic analysis, while more secure data such as personal information and banking details may be encrypted such that the proxy acts as an end-point only for the transport layer encryption. Additionally, a further channel 304 may be provided for data which skips the proxy entirely. In this way the end nodes can control how much data is exposed to the proxy.

The proxy is able to perform traffic management functions such as:
changing the priority of the stream;
selecting the up and down-stream flow control to be used in other hops of the broadband access network;
mapping and configuration of transport or link layer, including radio link functionality where applicable;
shaping and policing of the HTTP streams by throttling and/or discarding HTTP messages. The throttling may be performed by using HTTP/2 and/or transport protocol mechanisms, or by the proxy sending instructions to a control function 305 of the network (such as a radio scheduler);
delivering the HTTP messages either on request by the destination end node, or opportunistically without a request from the destination end node.

Alternatively, these functions may be performed by a control function 305. The response performed by the proxy (or control function) is chosen on the basis of policies provided by a policy function 306.

The HTTP requests may contain information enabling the secure HTTP proxy to deduce type and characteristics of a stream, such as URL-information, HTTP headers such as Content Type, etc. It may however also be so that none such information is available due to the origin server removing such information. The proxy may instead be provided with metadata information from the origin server about the stream of HTTP messages, some of which that may include an encrypted and/or integrity protected payload.

FIG. 4 is a flowchart of a method of managing network resources across a broadband access network. A slice of the total available network resources is allocated S11 to an application service provider, where the service provider utilises said slice to provide one or more services to a multiplicity of client devices. Traffic is monitored S12 in a transport layer of the broadband access network to determine one or more parameters indicative of traffic flow. Said parameter(s) are passed S13 to the application layer at an application layer end point of the application service. The parameter(s) are used S14 at the application layer to manage traffic specific to the services and achieve efficient use of said slice.

FIG. 5 is a schematic diagram of an apparatus 10 configured to operate as an application layer end point for an application service in a broadband access network, wherein the application service utilises a slice of the broadband access network which is allocated to the application service. The apparatus comprises a transceiver 11 and a processor 12. The transceiver 11 is configured to communicate with the broadband access network. The processor 12 is configured to:
receive from a transport layer entity, via the transceiver, one or more parameters indicative of traffic flow of the broadband network;
pass said parameters to an application layer process
use the parameter(s) at the application layer to manage traffic specific to the services and achieve efficient use of said slice.

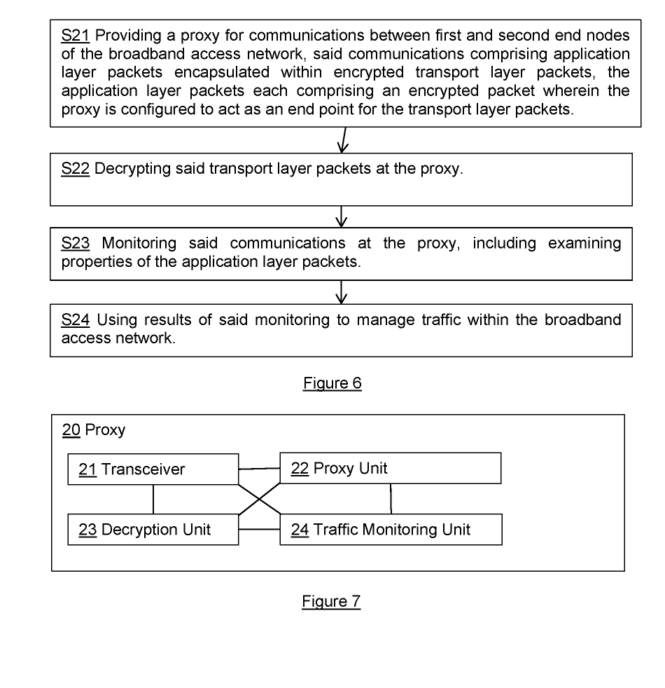

FIG. 6 is a flowchart of a a method of managing network resources across a broadband access network. A proxy is provided S21 for communications between first and second end nodes of the broadband access network, said communications comprising application layer packets encapsulated within encrypted transport layer packets, wherein the proxy is configured to act as an end point for the transport layer packets. Said transport layer packets are decrypted S22 at the proxy. Said communications are monitored S23 at the proxy, including examining headers of the application layer packets. Results of said monitoring are used S24 to manage traffic within the broadband access network.

FIG. 7 is a schematic diagram of an apparatus 20 configured to operate as a proxy in a broadband access network. The apparatus 20 comprises a transceiver 21, a proxy unit 22, a decryption unit 23, and a traffic monitoring unit 24. The transceiver 21 is configured to communicate with the broadband access network. The proxy unit 22 is configured to provide a proxy for communications between first and second end nodes of the broadband access network, said communications comprising application layer packets encapsulated within encrypted transport layer packets, wherein the proxy unit is configured to act as an end point for the transport layer packets. The decryption unit 23 is configured to decrypt the transport layer packets. The traffic monitoring unit 24 is configured to monitor said communications, including examining headers of the application layer packets, and to provide results of said monitoring to a control function of the broadband access network or use results of said monitoring to manage traffic within the broadband access network.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein.

1. A method of managing network resources across a broadband access network, the method comprising:
allocating a slice of the total available network resources to an application service provider, where the service provider utilises said slice to provide one or more services to a multiplicity of client devices;
monitoring traffic in a transport layer of the broadband access network to determine one or more parameters indicative of traffic flow;
passing said parameter(s) to the application layer at an application layer end point of the application service; and
using the parameter(s) at the application layer at the application layer end point to manage traffic specific to the services and achieve efficient use of said slice.

2. The method according to claim 1, wherein said parameters comprise one or more of:
a proportion of the total capacity of the broadband access network in use;
a proportion of the total capacity of the broadband access network in use by the services;
a proportion of network resources of the slice used by the services;
a weighted value corresponding to the network resources consumed by the services.

3. The method according to claim 1, wherein each of said parameters is determined for each of the client devices or for each application flow.

4. The method according to claim 1, wherein each of said parameters is determined for each of a multiplicity of areas of the broadband access network.

5. The method according to claim 1, wherein managing traffic specific to the services comprises any one or more of:
adjusting priorities of application flows;
adjusting bitrates of application flows;
providing respective traffic policies to a congestion and/or flow control systems for connections between the service provider and each of the client devices;
instructing the transport layer to terminate one or more application flows;
assigning application flows to queues of the broadband access network on the basis of cost levels for the queues;
providing a target traffic rate to the transport layer;
providing application flow priority settings to the transport layer;
returning a parameter to the transport layer indicating traffic management actions performed;
using QUIC traffic management mechanisms.

6. An apparatus configured to operate as an application layer end point for an application service in a broadband access network, wherein the application service utilises a slice of the broadband access network which is allocated to the application service, the apparatus comprising:
a transceiver configured to communicate with the broadband access network;
a processor configured to:
receive from a transport layer entity, via the transceiver, one or more parameters indicative of traffic flow of the broadband network;
pass said parameters to an application layer process use the parameter(s) at the application layer to manage traffic specific to the services and achieve efficient use of said slice.

7. The apparatus according to claim 6, wherein said parameters comprise one or more of:
a proportion of the total capacity of the broadband access network in use;
a proportion of the total capacity of the broadband access network in use by the services;
a proportion of network resources of the slice used by the services;
a weighted value corresponding to the network resources consumed by the services.

8. The apparatus according to claim 6, wherein each of said parameters relates to a respective client device to which the application service is provided or relates to a respective area of the broadband network.

9. The apparatus according to claim 6, wherein the processor is configured to manage traffic specific to the services by performing any one or more of:
adjusting priorities of application flows;
adjusting bitrates of application flows;
providing respective traffic policies to a congestion and/or flow control systems for connections between the service provider and each of the terminals;
instructing the transport layer to terminate one or more application flows;
assigning application flows to queues of the broadband access network on the basis of cost levels for the queues;
providing a target traffic rate to the transport layer;
providing application flow priority settings to the transport layer;
returning a parameter to the transport layer indicating traffic management actions performed.

10. A method of managing network resources across a broadband access network, the method comprising:
providing a proxy for communications between first and second end nodes of the broadband access network, said communications comprising application layer packets encapsulated within encrypted transport layer packets, the application layer packets each comprising an encrypted payload, wherein the proxy is configured to act as an end point for the transport layer packets;
decrypting said transport layer packets at the proxy;
monitoring said communications at the proxy, including examining properties of the application layer packets;
using results of said monitoring to manage traffic within the broadband access network.

11. The method according to claim 10, wherein examining properties of the application layer packets comprises examining headers of the application layer packets and/or examining traffic patterns in the payload of the application layer packets.

12. The method according to claim 10 and comprising decrypting said payloads of the application layer packets at the proxy;
wherein monitoring said communications includes examining the payloads of the application layer packets.

13. The method according to claim 10, and comprising, at the end nodes, selecting for each application layer packet one of:
encrypting the payload of the application layer packet with the proxy as an end point;
encrypting the payload of the application layer packet with the other end node as an end point, and not the proxy as an end point;
decrypting said application layer packets with the proxy as an end point at the proxy, and wherein monitoring said communications includes examining the payloads of the application layer packets with the proxy as an end point.

14. The method according to claim 13, wherein said step of selecting is performed on the basis of the payload of each application layer packet.

15. The method according to claim 10, wherein said step of using results of said monitoring to manage traffic is performed at the proxy.

16. The method according to claim 15, and comprising the proxy receiving policies from a policy function of the broadband access network, wherein the step of using results of said monitoring to manage traffic is performed on the basis of said policies.

17. The method according to claim 10, and comprising sending results of said monitoring to a control function of the broadband access network, and wherein said step of using results of said monitoring to manage traffic is performed by the control function.

18. The method according to claim 10, wherein said step of using results of said monitoring to manage traffic comprises any one or more of:
changing a priority of the communications;
selecting up and down-stream flow control to be used in other hops of the broadband access network;
mapping and configuration of transport or link layer;
shaping and policing of the communications by throttling and/or discarding packets;
delivering the packets either on request by the destination end node, or opportunistically without a request from the destination end node.

19. An apparatus configured to operate as a proxy in a broadband access network, the apparatus comprising:
a transceiver configured to communicate with the broadband access network;
a proxy unit configured to provide a proxy for communications between first and second end nodes of the broadband access network, said communications comprising application layer packets encapsulated within encrypted transport layer packets, the application layer packets each comprising an encrypted payload, wherein the proxy unit is configured to act as an end point for the transport layer packets;
a decryption unit configured to decrypt the transport layer packets;
a traffic monitoring unit configured to monitor said communications, including examining properties of the application layer packets, and to provide results of said monitoring to a control function of the broadband access network or use results of said monitoring to manage traffic within the broadband access network.

20. The apparatus according to claim 19, wherein said traffic monitoring unit is configured to examine headers of the application layer packets and/or examine traffic patterns in the payload of the application layer packets.

21.-24. (canceled)
